(19) United States
(12) Patent Application Publication
(10) Pub. No.: US 2016/0365925 A1
(43) Pub. Date: Dec. 15, 2016

(54) OPTICAL COMMUNICATIONS MODULE HAVING A CROSSED-BEAM OPTICS SYSTEM

(71) Applicant: Avago Technologies General IP (Singapore) Pte. Ltd., Singapore (SG)

(72) Inventor: Omid Momtahan, Palo Alto, CA (US)

(21) Appl. No.: 14/734,022

(22) Filed: Jun. 9, 2015

(51) Int. Cl. H04B 10/25; H04B 10/2507; G02B 6/42

(52) U.S. Cl. CPC H04B 10/2503; G02B 6/4257; G02B 6/4215; G02B 6/4295; H04B 10/2507

(57) ABSTRACT

A bidirectional (BiDi) optical communications module is provided that utilizes a crossed-beam optics system configuration that improves space utilization in the module while also reducing the occurrence of electrical and optical crosstalk in the module. The crossed-beam optics system configuration causes the optical pathways associated with each port to cross in an area that is typically an unused, or wasted, area in existing BiDi optical communications modules. By utilizing this typically unused area, spatial constraints on the placement of module components are relaxed. Relaxing these spatial constraints allows the optical source die and the optical detector die to be positioned far enough apart from one another that electrical and optical crosstalk do not occur, or at least are greatly reduced. In addition, relaxing the spatial constraints allows electrical trace lengths to be reduced, which leads to improvements in signal integrity and overall performance.

### TECHNICAL FIELD

The invention relates to optical communications modules. More particularly, the invention relates to an optical communications module having a crossed-beam optics system that improves space utilization, reduces optical and electrical crosstalk and improves signal integrity.

### BACKGROUND

A variety of optical communications modules exist for transmitting and/or receiving optical data signals over optical waveguides (e.g., optical fibers). Optical communications modules include optical receiver modules, optical transmitter modules and optical transceiver modules. Optical receiver modules have one or more receive channels for receiving one or more optical data signals over one or more respective optical waveguides. Optical transmitter modules have one or more transmit channels for transmitting one or more optical data signals over one or more respective optical waveguides. Optical transceiver modules have one or more transmit channels and one or more receive channels for transmitting and receiving respective optical transmit and receive data signals over respective transmit and receive optical waveguides. For each of these different types of optical communications modules, a variety of designs and configurations exist.

On the receive side of an optical receiver or transceiver module, an optical data signal passing out of the end of an optical fiber is coupled by an optics system onto an optical detector, such as a P-intrinsic-N (PIN) diode or other type of photodiode. The optical detector converts the optical data signal into an electrical data signal, which is then amplified and processed to recover the data. The amplification process is typically performed by a transimpedance amplifier (TIA) and the data recovery process is typically performed by a receiver integrated circuit (IC). On the transmit side of an optical transmitter or transceiver module, a driver IC outputs electrical data signals to an optical source, such as a laser diode or a light emitting diode (LED), to cause the optical source to generate optical data signals. An optics system couples the optical data signals into an end of an optical fiber. The optical source, optical detector, driver IC and receiver IC are typically mounted on and electrically interconnected with a printed circuit board (PCB) of the module.

In order to meet ever-increasing demands for higher information bandwidth, state-of-the-art digital communication switches, servers, and routers often use multiple rows of optical communications modules arranged in very close proximity to one another to increase module density. More recently, bidirectional (BiDi) optical communications modules have been developed to further increase information bandwidth capabilities by both transmitting and receiving optical data signals over each optical channel using multiple wavelengths. In other words, each optical channel is a bidirectional optical channel that uses different wavelengths for the optical signals being transmitted and received over the channel. Optics systems of BiDi optical communications modules include optical elements, such as optical filters, for example, that perform optical wavelength division multiplexing (MUXing) and demultiplexing (DeMUXing) operations to combine and separate optical signals of different wavelengths. The optics systems typically also include various other optical elements that perform reflecting, focusing and collimating operations.

One of the disadvantages of current BiDi optical communications modules is that they typically utilize space in front of each optical port for placement of the optical elements that perform the MUXing and DeMUXing operations on the optical signals being coupled into and out of the port. Because of space limitations in the modules, this use of the space in front of the ports imposes constraints on the placement of other components of the module, such as the laser diode die and the PIN diode die. In particular, the use of the space in front of the ports for MUXing and DeMUXing optical elements typically results in the laser diode die and the PIN diode die being placed very close to one another on the module PCB. This close proximity of the laser diode die and the PIN diode die to one another tends to increase both optical and electrical crosstalk. In addition, the placement constraints also often result in the driver and receiver IC dies being separated from the laser diode die and the PIN diode die, respectively, by significant distances. Consequently, the electrically-conductive traces that interconnect these components are typically relatively long, which can lead to signal integrity problems due to the high inductances of the traces.

Accordingly, a need exists for a BiDi optical communications module that has improved space utilization that reduces or eliminates the occurrence of electrical and optical crosstalk in the module and that improves signal integrity and overall performance of the module.

### BRIEF DESCRIPTION OF THE DRAWINGS

FIG. 1 illustrates a top plan view of a crossed-beam optics system of a BiDi optical communications module in accordance with an illustrative embodiment.

FIG. 2 illustrates a top perspective view of the crossed-beam optics system shown in FIG. 1.

FIG. 3 illustrates a back plan view of the crossed-beam optics system shown in FIG. 1.

FIG. 4 illustrates a front plan view of the crossed-beam optics system shown in FIG. 1.

FIG. 5 illustrates a top plan view of a portion of the crossed-beam optics system shown in FIG. 1.

FIG. 6 illustrates a back plan view of the portion of the crossed-beam optics system shown in FIG. 5.

FIG. 7 illustrates a top plan view of a crossed-beam optics system of a BiDi optical communications module in accordance with another illustrative embodiment.

FIG. 8 illustrates a top perspective view of a BiDi optical communications module in accordance with an illustrative embodiment comprising the crossed-beam optics system 1 shown in FIG. 1.

FIG. 9 illustrates a enlarged top perspective view of the portion of the BiDi optical communications module shown in the dashed circle labeled with reference numeral 75 in FIG. 8.

### DETAILED DESCRIPTION OF ILLUSTRATIVE EMBODIMENTS

In accordance with illustrative, or exemplary, embodiments described herein, a BiDi optical communications module is provided that utilizes a crossed-beam optics system configuration that improves space utilization in the module while also reducing the occurrence of electrical and optical crosstalk in the module. The crossed-beam optics system configuration causes the optical pathways associated with each port to cross in an area that is typically an unused, or wasted, area in existing BiDi optical communications modules. By utilizing this typically unused area, the aforementioned constraints on the placement of module components are relaxed, which allows the optical source die and the optical detector die to be positioned far enough apart from one another that electrical and optical crosstalk do not occur, or at least are greatly reduced.

In accordance with an illustrative embodiment, the crossed beams are collimated beams over most of the optical pathways. The collimated shapes of the beams allow smaller optical elements (e.g., lenses) to be used in the optics system compared to if the beams were non-collimated beams (i.e., diverging beams). Also, using collimated beams provides larger tolerance limits for optical alignment. Using smaller lenses allows the IC dies (e.g., receiver and driver IC dies) that communicate with the optical source and optical detector dies to be placed very close to the optical source and detector dies, which allows the electrical traces that electrically connect the IC dies to the optical detector and optical source dies to be kept short. The short trace lengths result in the traces having low inductances, which leads to improvements in signal integrity and overall performance.

In addition, in accordance with an illustrative embodiment, most of the optical pathways are in air rather than some other medium (e.g., plastic or glass), which reduces optical losses and birefringence. Reducing optical losses and birefringence leads to further improvements in coupling efficiency of the light and overall performance.

Illustrative embodiments of the BiDi optical communications module are described herein with reference to the figures, in which like reference numerals represent like elements, features or components. It should be noted that features, elements or components in the figures are not necessarily drawn to scale, emphasis instead being placed on demonstrating principles and concepts of the invention.

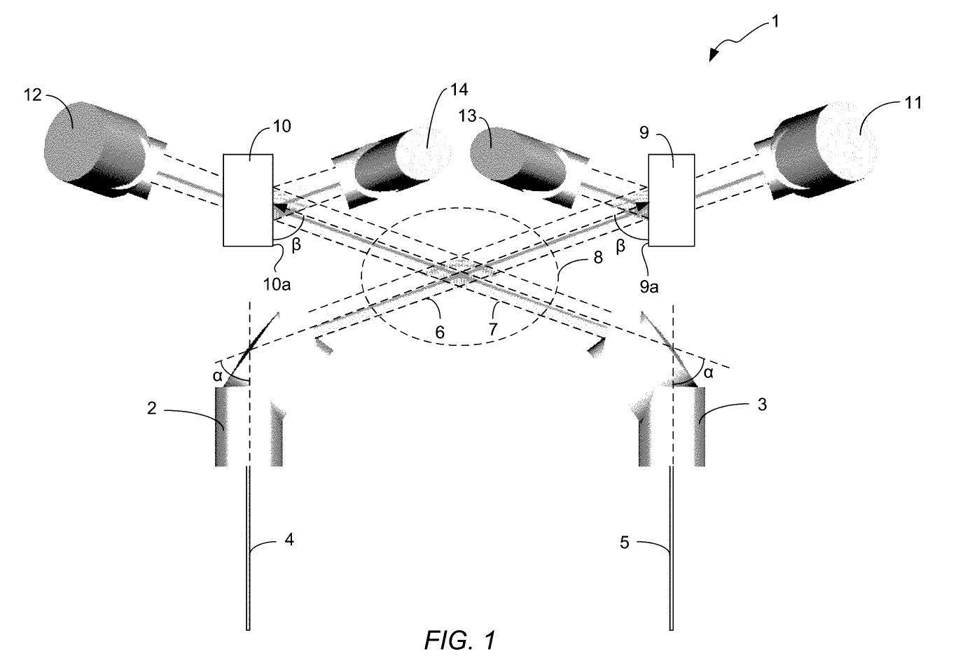

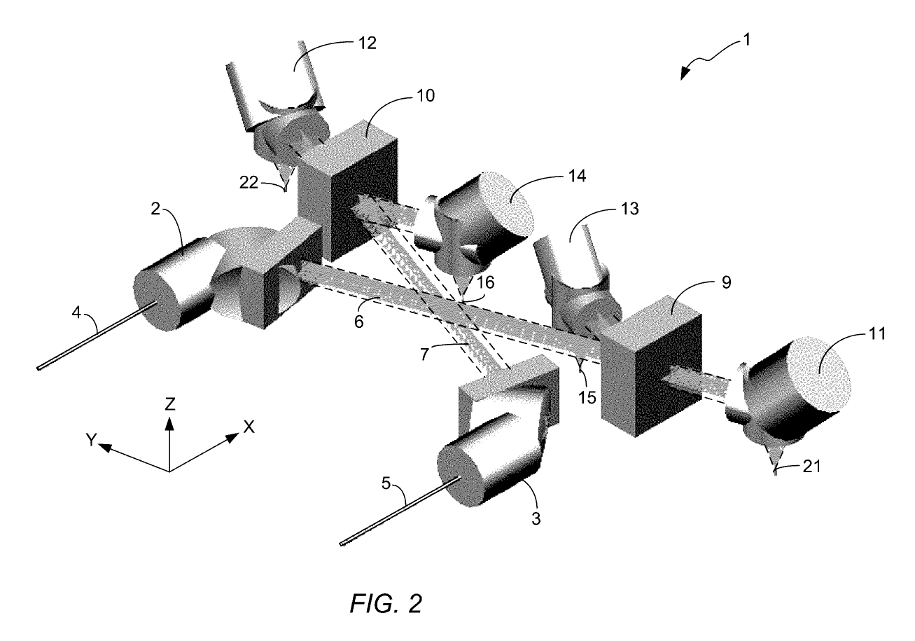

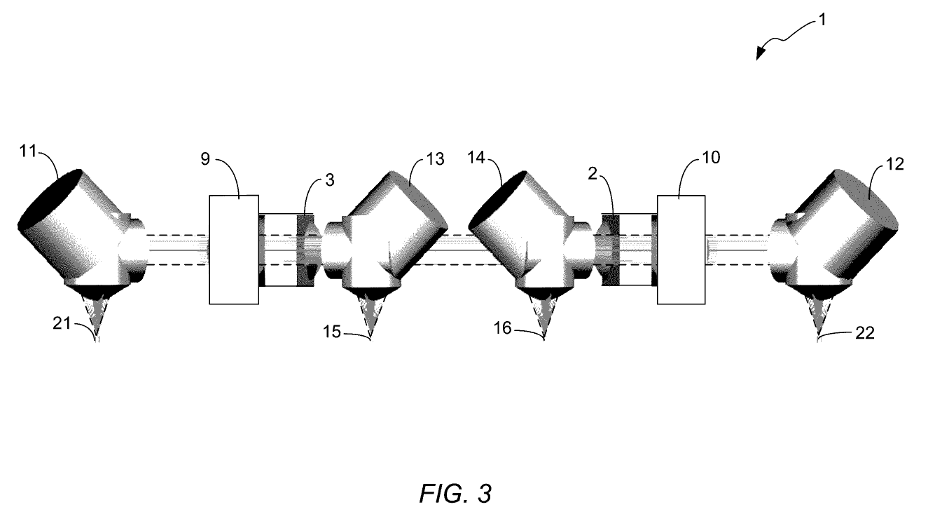

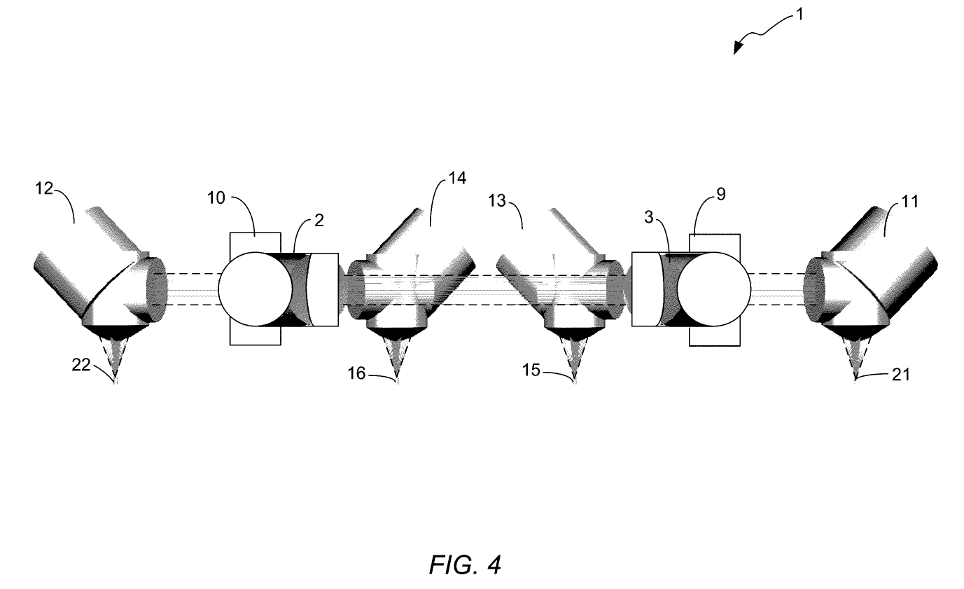

FIGS. 1-4 illustrate a top plan view, a top perspective view, a back plan view, and a front plan view, respectively, of a crossed-beam optics system 1 of a BiDi optical communications module in accordance with an illustrative embodiment. In FIGS. 1 and 2, first and second optical ports 2 and 3, respectively, of the module are shown connected to ends of first and second optical fiber cables 4 and 5, respectively. The optical fibers 4 and 5 are not shown in FIGS. 3 and 4. Also, for ease of discussing and illustrating the feature of the crossed-beam optics system 1, the module housing and other components of the module are not shown in FIGS. 1-7.

The first and second optical ports 2 and 3 have optical elements (not shown) that operate on first and second beams of light of first and second wavelengths, respectively, passing out of the ends of the first and second optical fibers 4 and 5, respectively. The optical ports 2 and 3 are mechanically coupled with ends of the first and second optical fibers 4 and 5, respectively. The optical ports 2 and 3 may be configured to mate directly with ends of the optical fibers 4 and 5 or with optical connectors (not shown) disposed on the ends of the optical fibers 4 and 5. The phrase “mechanically coupled with,” as that phrase is used herein, is intended to denote a direct or indirect mechanical or physical connection.

The optical elements (e.g., one or more total internal reflection (TIR) lenses) of the optical ports 2 and 3 collimate the received light beams into first and second collimated light beams, respectively, and direct the first and second collimated light beams along first and second optical pathways 6 and 7, respectively, toward optical components 9 and 10, which are first and second filter elements. The first and second collimated light beams cross or overlap one another in a central region in between the optical ports 2 and 3. The central region is represented generally by the dashed circle labeled with reference numeral 8 (FIG. 1). This central region 8 corresponds to the aforementioned typically unused area in BiDi optical communications modules.

The first and second filter elements 9 and 10 are reflective to light of the first and second wavelengths, respectively, and are transmissive to light of the second and first wavelengths, respectively. Optical components 13 and 14 receive the first and second collimated light beams reflected by the first and second filter elements 9 and 10, respectively, and focus and direct the received first and second collimated light beams onto first and second optical detectors 15 and 16, respectively (FIG. 2). The optical components 13 and 14 include optical elements (e.g., one or more TIR lenses) that perform the directing and focusing operations.

Optical components 11 and 12 of the optics system 1 receive respective light beams produced by first and second optical sources 21 and 22 (FIGS. 2-4), respectively, collimate the received light beams into the third and fourth collimated light beams, respectively, and direct the third and fourth collimated light beams toward the first and second optical ports 2 and 3, respectively. The third and fourth collimated light beams are of the second and first wavelengths, respectively, and therefore pass through the filter elements 9 and 10, respectively, without being filtered. The optical elements of the first and second optical ports 2 and 3 receive the third and fourth collimated light beams and focus them onto the ends of the first and second optical fibers 4 and 5, respectively.

As indicated above, in existing BiDi optical communications modules, the optical components that are used for performing the MUXing and DeMUXing operations are typically located in front of their respective optical ports. The central region 8 (FIG. 1) in between the optical ports is typically an unused area in existing BiDi optical communications modules. Such arrangements require the use of a relatively large area in front of the optical ports for separating and combining optical beams, which results in a relatively large amount of space on the module PCB in front of the optical ports being occupied. As described above, such configurations result in spatial constraints that limit the available locations that can be used for placement of the optical source dies and the optical detector dies. Consequently, the optical source die and the optical detector die in known BiDi designs are typically placed in very close proximity to one another, which can lead to optical and electrical crosstalk. Using the central region 8 to cross the beams relaxes spatial constraints, which results in better, or more efficient, utilization of the module PCB area. One advantage of this is that it allows the optical sources 21 and 22 to be spatially separated from the optical detectors 15 and 16, respectively, by distances that are sufficient to ensure that optical and electrical crosstalk between the sources 21 and 22 and the detectors 15 and 16, respectively, is eliminated or at least greatly reduced.

One advantage of using collimated light beams is that it allows small optical elements (e.g., lenses) to be used in performing the collimation, reflection and focusing operations. Using smaller optical elements allows the driver and receiver IC dies (not shown) to be placed in closer proximity to the optical source dies 21, 22 and to the optical detector dies 15, 16, respectively. When larger lenses are used in existing BiDi modules, there is typically insufficient space underneath the lenses to accommodate the height and/or the area of the driver and receiver IC dies due to the lengths of the lenses. For that reason, the driver and receiver IC dies are typically mounted off to the side of the respective optical source or optical detector die, which are typically centered on and mounted beneath the respective lenses. Such mounting arrangements typically require the use of relatively long traces for interconnecting the optical source or optical detector dies with the driver IC die or receiver IC die, which often leads to signal integrity problems.

Using collimated beams on the optical pathways 6 and 7 allows smaller lenses to be used for these purposes due to the narrow diameters of the collimated beams. Another important benefit of using the collimated beams is that larger tolerances are acceptable for optical alignment. As a result, the small lenses could be aligned with the respective optical ports 2 or 3 without having to maintain a high precision alignment between different optical elements. Also, using smaller lenses allows the driver and receiver IC dies to be mounted in very close proximity to the optical source dies 21, 22 and to the optical detector dies 15, 16, respectively, which, in turn, allows shorter trace lengths to be used in the module. Using shorter trace lengths leads to improvements in signal integrity. In addition, because almost the entire lengths of the optical pathways 6 and 7 are in air rather than in some other medium, such as plastic or glass, optical losses and birefringence are reduced, which also improves the optical coupling efficiency of the optical beam.

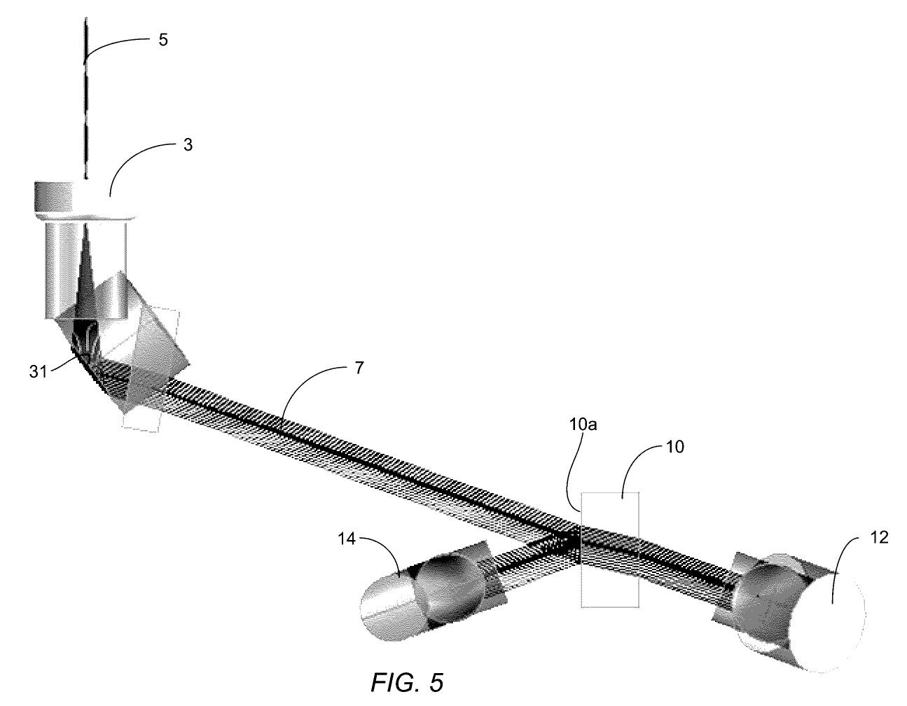

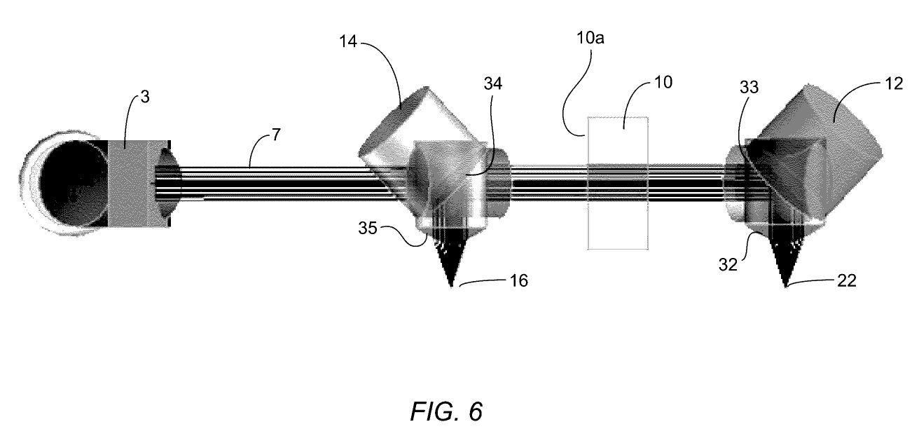

FIG. 5 illustrates a top plan view of a portion of the crossed-beam optics system shown in FIG. 1 that shows the manner in which the optical element of the optical port 3 operates on light passing out of the end of optical fiber 5 in accordance with an illustrative embodiment. FIG. 6 illustrates a back plan view of the portion of the crossed-beam optics system 1 shown in FIG. 5 that demonstrates the manner in which optical elements of the optical components 12 and 14 operate on light being transmitted to or received from the optical port 3. With reference to FIG. 5, light of the second wavelength that passes out of the end of optical fiber 5 is reflected and collimated by a TIR lens 31 of optical port 3. For light of the first wavelength being transmitted, the TIR lens 31 focuses the collimated light beam into the end of the optical fiber 5.

The filter element 10 may be a single-sided filter element comprising a filter coating applied to side 10a of the filter element 10. Light of the first wavelength produced by optical source die 22 (FIG. 6) is collimated by a collimating element 32 (FIG. 6) of the optical component 12 and reflected by a reflecting element (or flat TIR surface) 33 (FIG. 6) of the optical component 12 toward the filter element 10. The filter element 10 passes the collimated light beam of the first wavelength. At the optical port 3, the collimated beam of the first wavelength is focused by the TIR lens 31 (FIG. 5) into the end of the optical fiber 5 (FIGS. 1 and 2).

For light of the second wavelength received at the optical port 3 from the end of the optical fiber 5, the collimated light beam is reflected off of side 10a of the filter element 10 toward the optical component 14. With reference to FIG. 6, the optical component 14 includes an optical element 34, such as a TIR lens (e.g., a flat TIR surface or reflecting element), that reflects the collimated light beam toward the optical detector die 16. The optical component 14 includes an optical element 35, such as a focusing lens, that focuses the collimated light beam onto the optical detector 16.

In the crossed-beam optics system 1 described above, the optical elements that perform the MUXing and DeMUXing operations are located in front of the other optical port instead of being in front of the optical port that receives or transmits the light that is MUXed or DeMUXed. For example, optical components 10, 12 and 14 and the optical source 22 and detector 16 (FIG. 2) are in front of optical port 2 even though they perform the MUXing and DeMUXing operations associated with light that is transmitted or received at optical port 3. Likewise, optical components 9, 11 and 13 and the optical source 21 and detector 15 are in front of optical port 3 even though they perform the MUXing and DeMUXing operations associated with light that is transmitted or received at optical port 2. Thus, the optical components 10, 12 and 14 and the optical source 22 and detector 16 are nearer optical port 2 than optical port 3, and the optical components 9, 11 and 13 and the optical source 21 and detector 15 are nearer optical port 3 than optical port 2. It is this crossed-beam configuration in combination with the utilization of the area 8 (FIG. 1) that provides the advantages described above of reduced optical and electrical crosstalk, improved signal integrity and improved overall performance.

With reference again to FIG. 2, the first and second optical pathways 6 and 7 are shown as crossing one another in the X, Y and Z dimensions of the X, Y, Z Cartesian coordinate system shown in FIG. 2. In other words, the optical pathways 6 and 7 and the respective light beams that travel along them are shown as intersecting one another. This is not a requirement of the invention. The beams traveling along the first and second optical pathways 6 and 7 overlap one another in at some location in the central region 8 (FIG. 1), but may have different Z coordinate values, i.e., one of the beams may be above or below the other in the Z direction. Thus, the term “cross” is intended to denote that the beams overlap one another in the central region 8 (FIG. 1), i.e., they occupy the same X, Y space at some location in the central region 8, but may have the same or different Z values at that location. If the beams have the same X, Y and Z values, they intersect one another, whereas if the beams have the same X and Y values, but different Z values, they overlap one another, but do not intersect one another. In either case, the beams “cross” one another, as that term is used herein, but only intersect one another if they also have the same Z coordinate values at the crossing location.

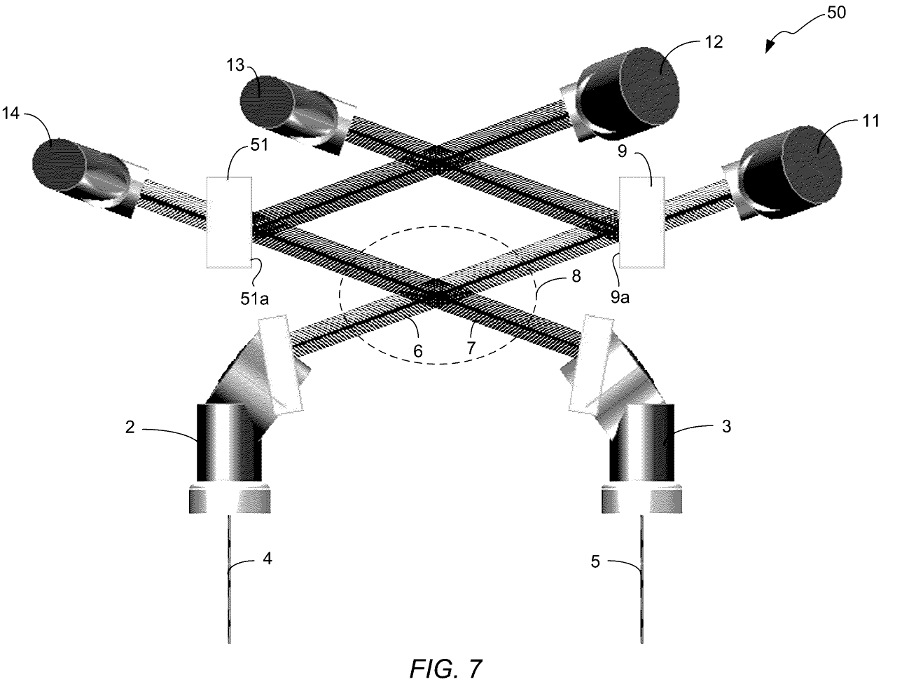

FIG. 7 illustrates a top plan view of a crossed-beam optics system 50 of a BiDi optical communications module in accordance with another illustrative embodiment. In the system 50, the optical sources 21 and 22 (not shown) and their respective optical components 11 and 12 are located in front of optical port 3 and the optical detectors 15 and 16 (not shown) and their respective optical components 13 and 14 are located in front of optical port 2. The first and second filter elements 9 and 51 are reflective to light of the first and are transmissive to light of the second wavelength. Light of the first wavelength generated by the optical source 22 is directed by optical component 12 onto side 51a of filter element 51. Side 51a has a filter thereon that directs light of the first wavelength onto optical pathway 7 in a direction toward optical port 3. Light of the second wavelength that passes out of the end of the second optical fiber 5 is directed by one or more optical elements of the optical port 3 onto the optical pathway 7 in a direction toward the optical filter element 51. The light of the second wavelength passes through the optical filter element 51 and is directed by optical component 14 onto optical detector 16 (not shown). In all other respects, the optics system 50 operates in the same manner as the optics system 1.

Like the optics system 1 shown in FIGS. 1-4, the optics system 50 shown in FIG. 7 provides similar advantages in terms of reduced optical and electrical crosstalk due to the relaxed spatial constraints that result from utilizing the area 8 for the optical pathways 6 and 7. The collimated beams of the system 50 provide the aforementioned advantages in terms of allowing smaller optical elements to be used, which leads to improvements in signal integrity and overall performance. In addition, because most of the optical pathways 6 and 7 of the system 50 are air, there is less signal loss and birefringence, which also improves signal integrity and overall performance. Another advantage of this embodiment is that only one type of filter element is needed as both filter elements 9 and 51 are reflective to light of the first wavelength and transmissive to light of the second wavelength.

As will be understood by those of skill in the art, there are an almost infinite number of ways in which to mount the components shown in FIGS. 1-7 inside of the housing (not shown) of the BiDi optical communications module to achieve the spatial relationships shown in FIGS. 1-7. In the interest of brevity, therefore, possible mounting configurations are not described herein in detail. In general, the components shown in FIGS. 1-7 are mounted inside of the module housing in such a way that the dies 15, 16, 21 and 22 are precisely aligned with the respective optical components 9-14 and such that the optical components 9-14 and the respective optical ports 2 and 3 are precisely aligned with one another.

One way to accomplish this is to use a component mounting block (CMB) or a lens frame for holding the optical components 9-14. The CMB or lens frame may be part of a module printed circuit board (PCB) or it may be a separate part that is mounted on the module PCB. In either case, there is a precise relationship between the CMB or lens frame and the dies on the module PCB. The CMB or lens frame is configured to hold the optical components 9-14 at predetermined, precise locations and with predetermined, precise orientations to achieve desired, precise spatial relationships between the optical ports 2 and 3 and the respective optical components 9-14 and between the respective optical components 9-14 and the dies 15, 16, 21 and 22. The dies 15, 16, 21 and 22 are mounted at precise locations on the module PCB such that there is a precise spatial relationship between the CMB or lens frame and the dies. Because the CMB or lens frame is configured to hold the optical components 9-14 at precise locations and with precise orientations, securing the optical components 9-14 to the CMB or lens frame at their predetermined locations with their predetermined orientations results in precise passive alignment of the dies 15, 16, 21 and 22 with the respective optical components 11-14. The CMB or lens frame and the dies 15, 16, 21 and 22 can be aligned with high precision with respect to each other independent of the precision with which the dies 15, 15, 21 and 22 are mounted on the module PCB.

The optical components 9, 11 and 13 in FIG. 1 and optical components 9, 51 and 13 in FIG. 7 may be integrated in a single, monolithically-formed piece part of a suitable optical material or they may be formed as multiple piece parts of a suitable optical material. Likewise, the optical components 10, 12 and 14 may be integrated into a single, monolithically-formed piece part or they may be formed as multiple piece parts of a suitable optical material. The optical source dies 21 and 22 and the optical detector dies 15 and 16 will typically be separate dies to ensure that the distance in between the optical source dies 21 and 22 and the optical detector dies 15 and 16 is sufficient to avoid optical and electrical crosstalk. The optical source dies are typically vertical cavity surface emitting laser (VCSELs) dies and the optical detector dies are typically PIN diode dies, although other types of optical sources and optical detectors may be used for this purpose.

The filter elements 9, 10 and 51 may be, for example, glass blocks with filter coatings located on one or both sides thereof. Typically, the filter coatings will only be on the sides 9a, 10a and 51a of the blocks, i.e., the sides that face the optical detector dies 15 and 16. Locating the filter coatings only on one side (e.g., side 10a in FIG. 5) of the blocks of the filter elements 9, 10 and 51 allows the filter elements 9, 10 and 51 to be made relatively inexpensively and facilitates handling of the filter elements 9, 10 and 51. Other types of filters may be used for this purpose, such as, for example, an optical etalon or a grating-based filter (e.g., a diffractive or holographic filter).

As indicated above, the use of collimated light beams over most of the optical pathways 6 and 7 allows relatively small optical elements to be used in the optical components 11-14. An additional advantage of having the ability to use small optical elements is that they are easier to passively align with the respective optical detector and source dies 15, 16, 21 and 22 and with other optical elements in the optical path. For example, if a CMB or lens frame is used for mounting the optical components 11-14 in the module, the optical components 11-14 can be secured to respective shelves of the CMB or lens frame using a curable adhesive material (e.g., an ultraviolet light (UV)-curable epoxy) to hold them in position. If the optical components 11-14 that are used are small in size, which is possible due to the collimated shapes of the beams, [AT1] epoxy will be sufficiently strong to permanently hold them in position.

With reference again to FIG. 1, the optical axes of the optical pathways 6 and 7 are at a first angle, α, to first and second optical axes of the first and second optical ports 2 and 3, respectively. The optical axes of the optical pathways 6 and 7 are at a second angle, β, to the sides 9a and 10a of the filter elements 9 and 10. For illustrative purposes, the sides 9a and 10a of the filter elements 9 and 10 are shown as being parallel to the optical axes of the optical fibers 4 and 5. Therefore, in accordance with this illustrative embodiment, β is equal to α. It should be noted, however, that β can be different from α. For example, the filter elements 9 and 10 could be tilted to make β less than α. The angle α typically ranges from about 10° to less than 90° and is typically about 20°. The angle β typically ranges from about 10° to less than 90° and is typically about 20°. The smaller the angle β is, the easier and less expensive the filter coatings disposed on sides 9a and 10a are to manufacture.

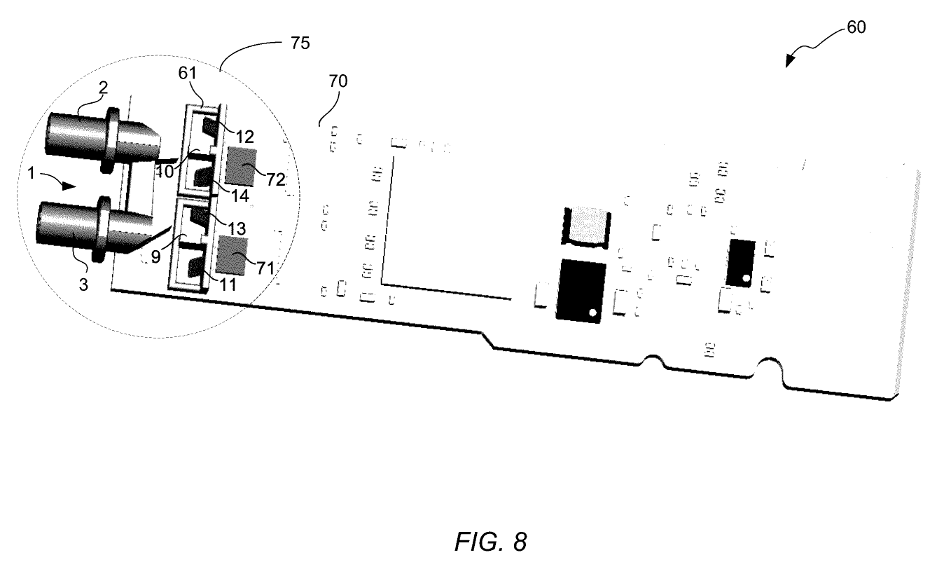

FIG. 8 illustrates a top perspective view of a BiDi optical communications module 60 in accordance with an illustrative embodiment that incorporates the crossed-beam optics system 1 shown in FIG. 1. The housing of the BiDi optical communications module 60 is not shown in FIG. 8 to allow the optics system 1 and the module PCB 70 to be easily seen. In accordance with this illustrative embodiment, the optical ports 2 and 3 are secured directly to an upper surface of the module PCB 70 and the optical components 9-14 are mounted in a lens frame 61 that is directly secured to the upper surface of the module PCB 70. First and second IC dies 71 and 72 are also mounted on the upper surface of the module PCB 70. Each of the first and second IC dies 71 and 72 comprise driver circuitry for driving the optical source dies (not shown) and receiver circuitry for processing electrical signals produced by the optical detector dies (not shown) to recover data. In other embodiments, the two functionalities can be separated into two ICs.

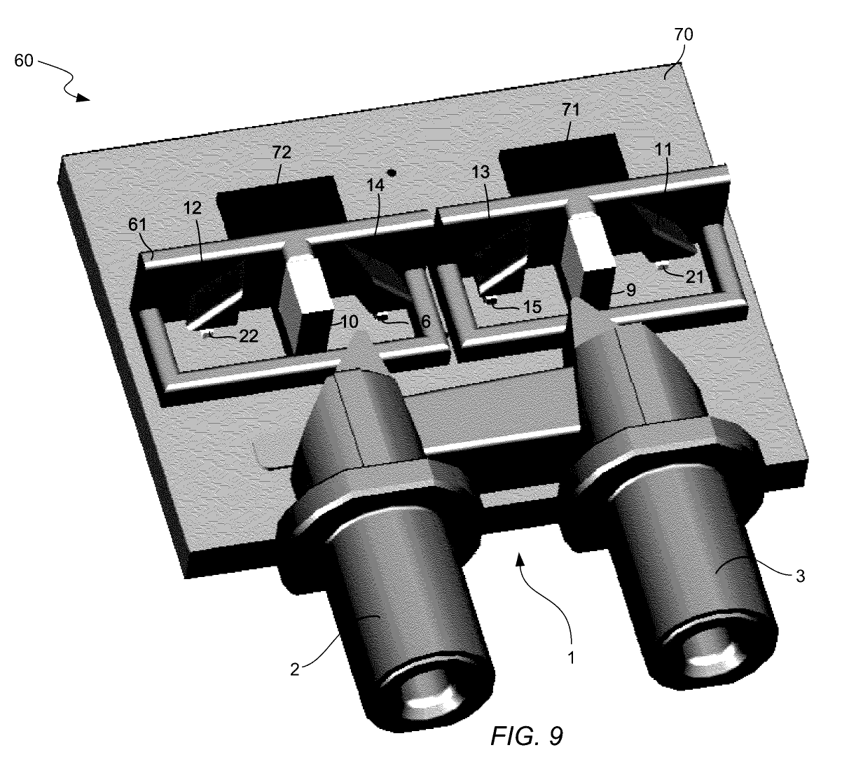

FIG. 9 illustrates an enlarged top perspective view of the portion of the BiDi optical communications module 60 shown in the dashed circle labeled with reference numeral 75 in FIG. 8. In FIG. 9, the optical source dies 21 and 22 and the optical detector dies 15 and 16 are visible beneath their respective optical components 11, 12, 13 and 14. The crossed-beam optics system 1 operates in the manner described above with reference to FIGS. 1-4. The first and second IC dies 71 and 72 drive the optical source dies 21 and 22, respectively, and process the electrical signals produced by the optical detector dies 15 and 16, respectively, to recover data. It should be noted that the crossed-beam optics system 50 shown in FIG. 7 could instead be used in the BiDi optical communications module 60 shown in FIGS. 8 and 9.

The IC dies 71 and 72 are positioned in close proximity to the optical source dies 21 and 22 and the optical detector dies 15 and 16 so that the electrical traces (not shown) of the PCB 70 that interconnect the dies 15, 16, 21, 22 with the respective dies 71 and 72 are kept relatively short, which leads to improvements in signal integrity. Although the dies 15, 16, 21, 22 71, and 72 are shown as being mounted directly on the upper surface PCB 70, some or all of the dies 15, 16, 21, 22, 71, and 72 could instead be mounted on one or more mounting blocks, such as one or more metal heat sink or heat spreader blocks, which are mounted on the PCB 70. Therefore, although the dies 15, 16, 21, 22, 71, and 72 are shown mounted directly on the PCB 70, they may be mounted indirectly on the PCB 70 by using some one of these other types of mounting structures (not shown).

The manner in which BiDi optical communications modules operate is known in the art. With reference again to FIGS. 1-4, the optical detector dies 15 and 16 detect light of the first and second wavelengths, respectively, whereas the optical source dies 21 and 22 produce light of the second and first wavelengths, respectively, where the first and second wavelengths are different. Thus, each of the optical fibers 4 and 5 simultaneously carries light of the first and second wavelengths. The filter element 9 reflects light of the first wavelength traveling along optical pathway 6 onto the optical detector die 15 while passing light of the second wavelength produced by the optical source die 21. Likewise, the filter element 10 reflects light of the second wavelength traveling along optical pathway 7 onto the optical detector die 16 while passing light of the first wavelength produced by the optical source die 22.

It should be noted, however, that filter elements 9 and 10 could be configured or designed to reflect portions of the light of the second and first wavelengths, respectively, produced by the optical source dies 21 and 22, respectively, onto optional respective monitor photodiodes (not shown). The monitor photodiodes would then be used to monitor the power levels of light being produced by the optical source dies 21 and 22. This could be accomplished by placing filter coatings on the sides of the filter elements 9 and 10 that face the optical components 11 and 12. The filter coatings would be designed to pass portions of the light produced by the respective optical source dies 21 and 22 and to reflect portions of the light onto the monitor photodiodes. In some applications, the Fresnel reflection from those surfaces even without filter coatings is enough to provide the monitoring signal, which allows the filter block to be a single-side coated element.

It should be noted that the invention has been described with respect to illustrative embodiments for the purposes of describing the principles and concepts of the invention. The invention is not limited to these embodiments, as will be understood by persons of skill in the art. For example, while the invention has been described with reference to a particular BiDi optical communications module configuration, the principles and concepts of the invention apply to other optical communications module configurations or other MUX and DeMUX schemes. As will be understood by those skilled in the art in view of the description being provided herein, many modifications may be made to the embodiments described herein while still achieving the goals of the invention, and all such modifications are within the scope of the invention.

What is claimed is:

1. A bidirectional (BiDi) optical communications module comprising:
a circuit board having at least first and second optical sources and first and second optical detectors mounted directly or indirectly thereon, the first optical source generating a first light beam to be transmitted over a first optical fiber, the first optical detector detecting a second light beam passing out of the first end of the first optical fiber, the second optical source generating a third light beam to be transmitted over a second optical fiber, the second optical detector detecting a fourth light beam passing out of the first end of the second optical fiber; and
a crossed-beam optics system comprising:
a first optical port configured to be mechanically coupled with the first end of the first optical fiber; and
a second optical port configured to be mechanically coupled with the first end of the second optical fiber, the first optical source being positioned nearer to the second optical port than to the first optical port and the second optical source being positioned nearer to the first optical port than to the second optical port, and wherein the first and third light beams travel along optical pathways that include first and second optical pathways, respectively, and wherein the first and second optical pathways cross one another.

2. The BiDi optical communications module of claim 1, wherein the first optical detector is positioned nearer to the second optical port than to the first optical port and the second optical detector is positioned nearer to the first optical port than to the second optical port, and wherein the second and fourth light beams travel along optical pathways that include the first and second optical pathways, respectively.

3. The BiDi optical communications module of claim 2, wherein the first and second light beams are of second and first wavelengths, respectively, and wherein the third and fourth light beams are of the first and second wavelengths, respectively, the first and second wavelengths being different from one another.

4. The BiDi optical communications module of claim 3, further comprising:
a first optical component directing the first light beam generated by the first optical source onto the first optical pathway in a first direction that is toward the first optical port;
a second optical component directing the second light beam passing out of the first end of the first optical fiber onto the first optical pathway in a second direction that is opposite the first direction; and
a first optical filter element positioned in the first optical pathway, the first optical filter element receiving the second light beam travelling along the first light path and directing the second light beam toward the first optical detector, wherein the first optical filter element is transmissive to at least a portion of the first light beam directed onto the first optical pathway by the first optical component.

5. The BiDi optical communications module of claim 4, further comprising:
a third optical component directing the third light beam generated by the second optical source onto the second optical pathway in a third direction that is toward the second optical port;
a fourth optical component directing the fourth light beam passing out of the first end of the second optical fiber onto the second optical pathway in a fourth direction that is opposite the third direction; and
a second optical filter element positioned in the second optical pathway, the second optical filter element receiving the fourth light beam travelling along the second optical pathway and directing the fourth light beam toward the second optical detector, wherein the second optical filter element is transmissive to at least a portion of the third light beam directed onto the second optical pathway by the third optical component.

6. The BiDi optical communications module of claim 5, wherein the second and fourth optical components are disposed in the first and second optical ports, respectively, the first and third optical components being disposed proximate the first and second optical sources, respectively, the first optical filter element being positioned nearer to the second optical port than to the first optical port, the second optical filter element being positioned nearer to the first optical port than to the second optical port.

7. The BiDi optical communications module of claim 5, wherein the second and fourth optical components collimate the second and fourth light beams such that the second and fourth light beams traveling along the first and second optical pathways, respectively, are collimated second and fourth light beams, respectively.

8. The BiDi optical communications module of claim 7, wherein the first and third optical components collimate the first and third light beams such that the first and third light beams traveling along the first and second optical pathways, respectively, are first and third collimated light beams, respectively.

9. The BiDi optical communications module of claim 5, wherein the first and second optical filter elements are first and second optical filter coatings, respectively, disposed on first surfaces of first and second structures, the first and second structures and the first and second filter coatings being transmissive to light of the second and first wavelengths, respectively, the first and second filter coatings being reflective to light of the first and second wavelengths, respectively.

10. The BiDi optical communications module of claim 5, further comprising:
a fifth optical component disposed in between the first optical filter element and the first optical detector, the fifth optical component receiving the second light beam directed toward the first optical detector by the first optical filter element and coupling the second light beam onto the first optical detector; and
a sixth optical component disposed in between the second optical filter element and the second optical detector, the sixth optical component receiving the fourth light beam directed toward the second optical detector by the second optical filter element and coupling the fourth light beam onto the second optical detector.

11. The BiDi optical communications module of claim 1, wherein the first and second optical pathways are at a first angle, α, relative to first and second optical axes of the first and second optical ports, respectively, and wherein the first angle α is in a range of from about 10° to less than 90°.

12. The BiDi optical communications module of claim 1, wherein the first, second, third and fourth light beams are collimated light beams that travel mostly through air.

13. The BiDi optical communications module of claim 1, comprising:
a circuit board having at least first and second optical sources and first and second optical detectors mounted directly or indirectly thereon, the first optical source generating a first light beam to be transmitted over a first optical fiber, the first optical detector detecting a second light beam passing out of the first end of the first optical fiber, the second optical source generating a third light beam to be transmitted over a second optical fiber, the second optical detector detecting a fourth light beam passing out of the first end of the second optical fiber; and
a crossed-beam optics system comprising:
a first optical port configured to be mechanically coupled with the first end of the first optical fiber; and
a second optical port configured to be mechanically coupled with the first end of the second optical fiber, the first and second optical sources being positioned nearer to the second optical port than to the first optical port and the first and second optical detectors being positioned nearer to the first optical port than to the second optical port, and wherein the first and second light beams travel along optical pathways that include first and second optical pathways, respectively, that cross one another.

14. The BiDi optical communications module of claim 13, wherein the third and fourth light beams travel along optical pathways that include the first and second optical pathways, respectively.

15. The BiDi optical communications module of claim 14, wherein the first and second light beams are of second and first wavelengths, respectively, and wherein the third and fourth light beams are of the first and second wavelengths, respectively, the first and second wavelengths being different from one another.

16. The BiDi optical communications module of claim 15, further comprising:
a first optical component directing the first light beam generated by the first optical source onto the first optical pathway in a first direction that is toward the first optical port;
a second optical component directing the second light beam passing out of the first end of the first optical fiber onto the first optical pathway in a second direction that is opposite the first direction; and
a first optical filter element positioned in the first optical pathway, the first optical filter element receiving the second light beam travelling along the first light path and directing the second light beam toward the first optical detector, wherein the first optical filter element is transmissive to at least a portion of the first light beam directed onto the first optical pathway by the first optical component.

17. The BiDi optical communications module of claim 16, further comprising:
a third optical component directing the third light beam generated by the second optical source along a third optical pathway in a third direction;
a fourth optical component directing the fourth light beam passing out of the first end of the second optical fiber onto the second optical pathway in a fourth direction; and
a second optical filter element positioned in the second optical pathway, the second optical filter element receiving the third light beam travelling in the third direction and directing the third light beam along the second optical pathway toward the second optical port, wherein the second optical filter element is transmissive to at least a portion of the fourth light beam directed onto the second optical pathway by the fourth optical component such that said at least a portion of the fourth light beam passes through the second optical filter element and is incident on the second optical detector.

18. The BiDi optical communications module of claim 17, wherein the first, second, third and fourth optical components collimate the first, second, third and fourth light beams into first, second, third and fourth collimated light beams, respectively, and wherein the first, second, third and fourth collimated light beams travel mostly through air.

19. The BiDi optical communications module of claim 13, wherein the first and second optical pathways are at a first angle, α, relative to first and second optical axes of the first and second optical ports, respectively, and wherein the first angle α is in a range of from about 10° to less than 90°.

20. A method for improving space utilization in a bidirectional (BiDi) optical communications module, the method comprising:
with a crossed-beam optics system of the module, directing a first light beam passing out of an end of a first optical fiber mechanically coupled with a first optical port of the module from the first optical port to a first area that is nearer a second optical port of the module than the first optical port;
with the crossed-beam optics system of the module, directing a second light beam passing out of an end of a second optical fiber mechanically coupled with the second optical port from the second optical port to a second area that is nearer the first optical port than the second optical port, wherein the first and second light beams directed to the first and second areas cross one another before arriving at the first and second areas, respectively;
in the first and second areas, with the crossed-beam optics system, directing the first and second light beams onto first and second optical detectors that detect the first and second light beams, respectively.
in the first and second areas, using first and second optical sources to generate third and fourth light beams, respectively;
with the crossed-beam optics system, directing the third and fourth light beams toward the first and second optical ports, respectively, wherein the third and fourth light beams directed toward the first and second optical ports cross one another before arriving at the first and second optical ports, respectively; and
with the crossed-beam optics system, at the first and second optical ports, optically coupling the third and fourth light beams onto the ends of the first and second optical fibers, respectively, wherein the first and third light beams are of a first wavelength and the second and fourth light beams are of a second wavelength that is different from the first wavelength.

21. A method for improving space utilization in a bidirectional (BiDi) optical communications module, the method comprising:
with a crossed-beam optics system of the module, directing a first light beam generated by a first optical source located in a first area of the module onto a first optical pathway toward a first optical port of the module, wherein the first area is nearer a second optical port of the module than the first optical port;
with the crossed-beam optics system of the module, directing a second light beam generated by a second optical source located in the first area of the module onto a second optical pathway toward the second optical port of the module, wherein the first and second optical pathways cross one another;
with the crossed-beam optics system of the module, directing a third light beam passing out of an end of a first optical fiber mechanically coupled with the first optical port onto the first optical pathway toward the first area;
with the crossed-beam optics system of the module, directing a fourth light beam passing out of an end of a second optical fiber mechanically coupled with the second optical port onto the second optical pathway toward the second area;
with the crossed-beam optics system, directing the third light beam from the first area toward the second area;
with the crossed-beam optics system, directing the third and fourth light beams onto first and second optical detectors located in the second area; and
with the first and second optical detectors, converting the third and fourth light beams into respective electrical signals, wherein the first and second light beams are of first and second wavelengths, respectively, and the third and fourth light beams are of the second and first wavelengths, respectively, wherein the first and second wavelengths are different from one another.
